(19) United States
(12) Patent Application Publication
(10) Pub. No.: US 2009/0157209 A1
(43) Pub. Date: Jun. 18, 2009

(54) WIRE OPTION EXPRESSIONS IN WIRING HARNESS DESIGNS

(76) Inventor: Simon Edward Holdsworth, Gloucestershire (GB)

Correspondence Address: KLARQUIST SPARKMAN, LLP, 121 S.W. SALMON STREET, SUITE 1600, PORTLAND, OR, 97204, US

(21) Appl. No.: 11/957,313

(22) Filed: Dec. 14, 2007

(51) Int. Cl. G06F 19/00

(52) U.S. Cl. 700/97

(57) ABSTRACT

A method of designing a wiring harness using a wiring harness design tool can include creating a first wire option expression corresponding to a first wire within a wiring harness design, generating a wire option expression truth table based at least in part on the first wire option expression, modifying the first wire option expression truth table, and modifying the first wire option expression based at least in part on the modified wire option expression truth table.

### TECHNICAL FIELD

The disclosed technology relates to designing wiring harnesses including, but not limited to, electronic wiring harness design tools and methods of designing wiring harnesses using wire option expressions.

### BACKGROUND

Connectivity between electrical and electromechanical components (e.g., circuit packages, fuse panels, and circuit boards) can be accomplished by way of a wiring harness. A wiring harness generally refers to a collection (e.g., bundle) of one or more wires coupled together. One example of a wiring harness is a bundle of separately insulated wires that couple an automobile dashboard with the control electronics for the automobile's engine. Another example is a bundle of wires that couple an airplane cockpit to the wing assembly, engines, tail assembly, and landing gear.

Wiring harness diagrams can reduce a potentially complicated collection of wires to a readable map of components and connections. Wiring harnesses can be represented using wiring harness designs, which can include many physical details of the wires, couplings, and components of a particular wiring harness.

Software tools, such as the Capital® Harness Systems™ (CHS) product suite by Mentor Graphics Corporation, allow a user to design, analyze, and produce wiring harnesses for various types of electrical interconnect systems. The Capital® Logic™ tool is a schematic editing tool used in the creation of wiring harness designs, and allows a user to directly tag an electrical device with an electrical device option expression. The Capital® Integrator™ tool provides for the automatic synthesis of wires from connectivity definitions to ensure that the resulting wiring accurately reflects the intended connectivity.

Previous wiring harness design tools known to the inventor, however, have been limited in various aspects. In prior systems known to the inventor, the generation of wire option expressions yields various disadvantages that can make it difficult for users to make additional use of the wire option expressions in downstream processes such as calculating the cost of individual options, identifying the wires associated with a feature (e.g., in wiring designs), and modular harness design.

Thus, there exists a need for improved electronic wiring harness design tools and methods.

### SUMMARY

A wiring harness can be designed using a wiring harness design tool, for example. The wiring harness design tool can provide a wiring harness design workspace, in which a wiring harness design can be created or provided. Various electrical devices can be placed and edited as part of the wiring harness design process. Signals (e.g., to be carried through wires) can be placed, routed between the electrical devices, and spliced. A synthesis operation can be performed on at least a part of a wiring harness design to synthesize one or more wires.

One or more wire option expressions that correspond to respective wires within a wiring harness design can be created. In an exemplary approach, one or more wire option expression truth tables can be generated, wherein each wire option expression truth table corresponds to a wire option expression. Each wire option expression truth table can be modified (e.g., using an algorithm such as a reduction algorithm). A final (e.g., intermediate) wire option expression can be determined based at least in part on the corresponding modified wire option expression truth table. A final (e.g., intermediate) wiring harness design can be provided as an output.

The foregoing and other features and aspects of the disclosed technology will become more apparent from the following detailed description, which proceeds with reference to the accompanying figures.

### BRIEF DESCRIPTION OF THE DRAWINGS

FIG. 1 shows an exemplary general method of designing wiring harnesses using an electronic wiring harness design tool.

FIG. 2 shows an exemplary general method of creating and modifying a wire option expression.

FIG. 3 shows an exemplary set of several electrical devices and various wires and splices placed between the electrical devices.

FIG. 4 shows the exemplary set of electrical devices, wires, and splices of FIG. 3, as well as various exemplary wire option expressions determined for the corresponding wires.

FIG. 5 shows the exemplary set of several electrical devices, wires, and splices of FIG. 3, as well as a bypass wire.

FIG. 6 shows the exemplary set of several electrical devices, wires, bypass wire, and splices of FIG. 5, as well as an exemplary wire option expression determined for the bypass wire.

FIG. 7 shows an exemplary logic design that includes several electrical devices and a signal routed between them.

FIG. 8 shows an exemplary integration design resulting from replacing the electrical devices with slots and splitting the signal into three separate wire harness designs in the exemplary logic design of FIG. 7.

FIG. 9 shows an exemplary wiring design resulting from performing a synthesis operation on the exemplary integration design of FIG. 8.

FIG. 10 shows an exemplary computer program product operable to create and modify a wire option expression.

FIG. 11 is a block diagram of an exemplary computer network that can be used with the disclosed technology.

### DETAILED DESCRIPTION

Disclosed below are representative embodiments of methods, apparatus, and systems for designing wiring harnesses that should not be construed as limiting in any way. Instead, the present disclosure is directed toward all novel and nonobvious features and aspects of the various disclosed methods and systems, alone and in combination with one another. The disclosed technology is not limited to any specific aspect or feature, or combination thereof, nor do the disclosed methods and systems require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently.

Moreover, for the sake of simplicity, the attached figures may not show the various ways in which the disclosed methods, apparatus, and systems can be used in conjunction with other methods, apparatus, and systems. Additionally, the description may use terms such as “determine” and “identify” to describe the disclosed technology. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an” and “the” include the plural forms unless the context clearly dictates otherwise. Additionally, the term “includes” means “comprises.” Further, the term “coupled” means electrically connected or linked and does not exclude the presence of intermediate elements between the coupled items. The phrase “and/or” can mean “and,” “or,” or “both.”

### EXEMPLARY DEFINITIONS

For purposes of this specification, a wiring harness refers to a bundle of a plurality of wires coupled together that may include other components (e.g., connectors, splices, and multicores), wherein at least some of the wires terminate in at least one component such as a connector.

For purposes of this specification, a wire refers to a readily separable, typically insulated component for facilitating the passage of a signal and includes a standard conductor (e.g., copper) or any other type of applicable conductor (e.g., optical). When discussing a wiring harness design (e.g., in a wiring harness design workspace), the term ‘wire’ can refer to an electronic representation of a physical wire. During a synthesis operation on a wiring harness design, for example, wires can be synthesized from signals placed in the design.

For purposes of this specification, an electronic wiring harness design tool refers to a software tool or suite of such tools that provides a user with the ability to create, modify, and/or save at least one wiring harness design. As described elsewhere within this specification, the software tool or suite can be implemented in one or more tangible computer readable media and/or as a computer program product.

For purposes of this specification, a wiring harness design workspace refers to a partial or complete view (e.g., a topology) of the wiring harness makeup of an entity (e.g., a vehicle or portion of a vehicle). One or more topologies can be implemented within a single wiring harness design workspace.

For purposes of this specification, an electrical device refers to a device (e.g., an electrical control unit or a battery) that can be placed in a wiring harness design workspace (e.g., in a slot) and at which one or more wires can electrically terminate (e.g., through a connector).

For purposes of this specification, a bypass wire refers to a wire that can be placed between two nodes (e.g., splices) to circumvent other wiring that can electrically terminate at an electrical device (e.g., an electrical device sought to be circumvented).

For purposes of this specification, an option refers to an available feature for an entity that may or may not be in a specific embodiment of the entity. For example, an option can include an anti-lock braking system (ABS) feature of a vehicle.

For purposes of this specification, an option code refers to a code (e.g., an identifier that can be any number of characters, such as alphanumeric characters, but is typically short) that corresponds to an option. For example, an option code that refers to an ABS feature option could be “ANTI-LOCK BRAKING SYSTEM” or “ABS.”

For purposes of this specification, an option expression refers to an expression including one or more option codes that can make use of one or more binary operators such as ‘AND’ (a Boolean intersection), ‘OR’ (a Boolean union), and ‘NOT’ (a Boolean negation).

For purposes of this specification, an electrical device option expression refers to an option expression corresponding to an electrical device (e.g., placed in a wiring harness design workspace) or a pin of the electrical device. An electrical device option expression generally conveys the conditional inclusion of the associated electrical device in the vehicle corresponding to the wiring harness design workspace in which the electrical device is placed. Electrical device option expressions can be attached to the corresponding electrical devices or electrical device pins in a wiring harness design workspace by a user, for example.

For purposes of this specification, a wire option expression refers to an option expression corresponding to a wire or signal in a wiring harness design. A wire option expression can include an initial wire option expression and a final wire option expression, for example.

For purposes of this specification, a final wire option expression refers to a wire option expression that results from an application of the disclosed technology. A final wire option expression can be identical to an initial wire option expression or it can be a modified, intermediate, or completed version of an initial wire option expression, for example. A final wire option expression can be provided as an output.

For purposes of this specification, a truth table (e.g., a wire option expression truth table) refers to a data structure or a representation of a data structure that defines outputs that result from specified inputs. A truth table as used herein can be, but is not required to be of a specific form (e.g., rows and columns).

### Exemplary Wiring Harness Design

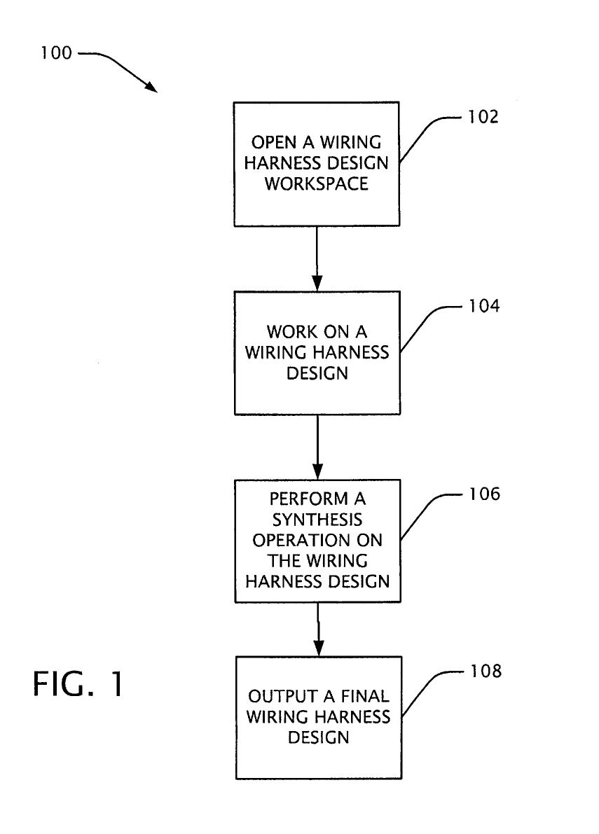

FIG. 1 shows a general method 100 of designing wiring harnesses using an electronic wiring harness design tool.

At 102, a user (e.g., a wiring harness designer) can open a wiring harness design workspace. The user can create a new wiring harness design workspace or open a previously-created wiring harness design workspace. In some embodiments, the user can open multiple wiring harness design workspaces within the same session.

At 104, the user can work on one or more wiring harness designs within the wiring harness design workspace. This can include creating new wiring harness designs and/or viewing, analyzing, editing, and/or saving previously-created wiring harness designs.

At 106, a synthesis operation can be performed on at least one of the one or more wiring harness designs within the wiring harness design workspace.

At 108, a final (e.g., modified, intermediate, or completed) wiring harness design can be provided as output from the wiring harness design workspace after the user has finished working.

### Exemplary Wire Option Expressions and Use Thereof in Wiring Harness Design

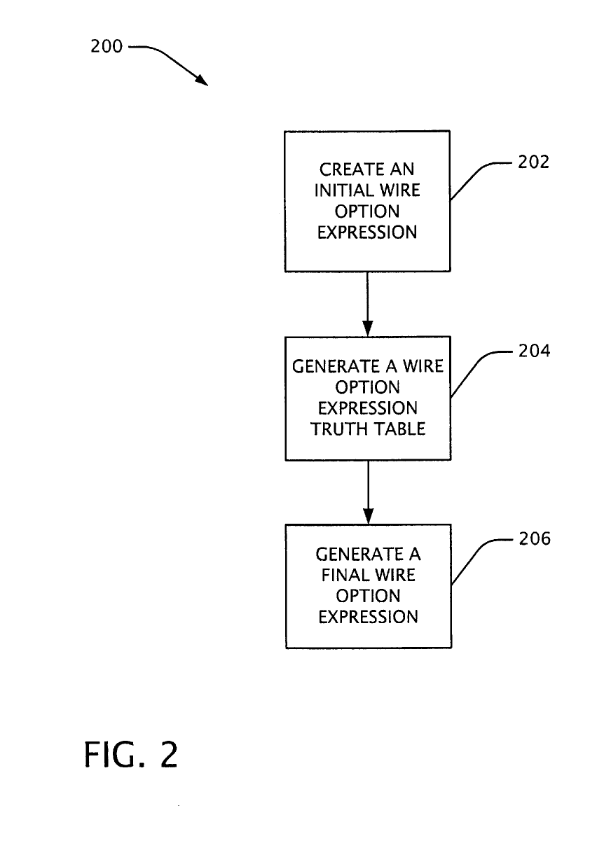

FIG. 2 shows an exemplary general method 200 of creating and modifying a wire option expression in accordance with exemplary methods described herein.

At 202, an initial wire option expression can be created for at least one wire within a wiring harness design. The initial wire option expression can be created based at least in part on the effective option expressions corresponding to each electrical device electrically coupled with the wire. Such an initial wire option expression, however, can be significantly large and complicated.

At 204, a wire option expression truth table can be generated based on the initial wire option expression. For example, the initial wire option expression can be binarily manipulated, such as into a “sum of products” form (e.g., (A1 & B1 & C1)|(A2 & B2 & C2)), which can then be translated into the wire option expression truth table. In some embodiments, normal expansion and De Morgan's theorem can be used in simplifying the initial wire option expression (e.g., into a “sum of products” form).

At 206, an algorithm (e.g., a reduction algorithm) can be used to generate a final wire option expression based on the wire option expression truth table. For example, using the algorithm can include the use of a function minimization algorithm (e.g., the ESPRESSO algorithm) to simplify (e.g., reduce the complexity of) the wire option expression truth table. Alternatively, a Karnaugh map or the Quine-McCluskey method could be used to simplify the wire option expression truth table. In some embodiments, wire option expressions can be calculated on demand (e.g., automatically or by a user request), thereby avoiding the cost of maintaining data consistency.

Among the various advantageous features of the disclosed technology are the ability to automatically determine and modify accurate and readable wire option expressions for one or more wires, and desirably every wire in a corresponding wiring harness design. Additionally, the disclosed technology can provide increased efficiency and effectiveness in the delivery of option cost information to a wiring harness design user. For example, a wire option expression can be determined for wiring that is always in the vehicle, and processes having significant variation can be managed effectively. Also, the selection of wire option expressions presented to a user can be complete.

### Exemplary Implementations of the Disclosed Technology

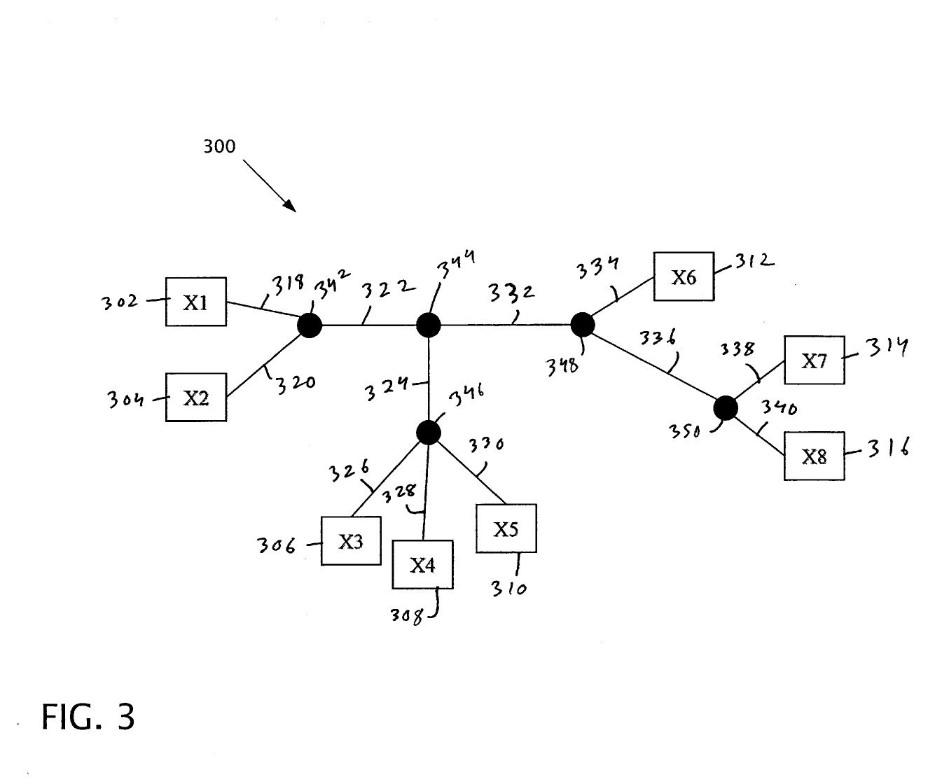

FIG. 3 shows an exemplary set 300 of several electrical devices 302-316 and various wires 318-340 and splices 342-350 placed between the electrical devices 302-316 (e.g., to facilitate a signal in a wiring harness design). In the example, each of the electrical devices 302-316 has an assigned electrical device option expression (e.g., X1).

In some embodiments, an electrical device option expression for an electrical device can represent a combination of various option expressions such as signal, logical device, logical device pin, and option-based placement expressions. Such option expressions can be combined (e.g., ANDed) together, for example.

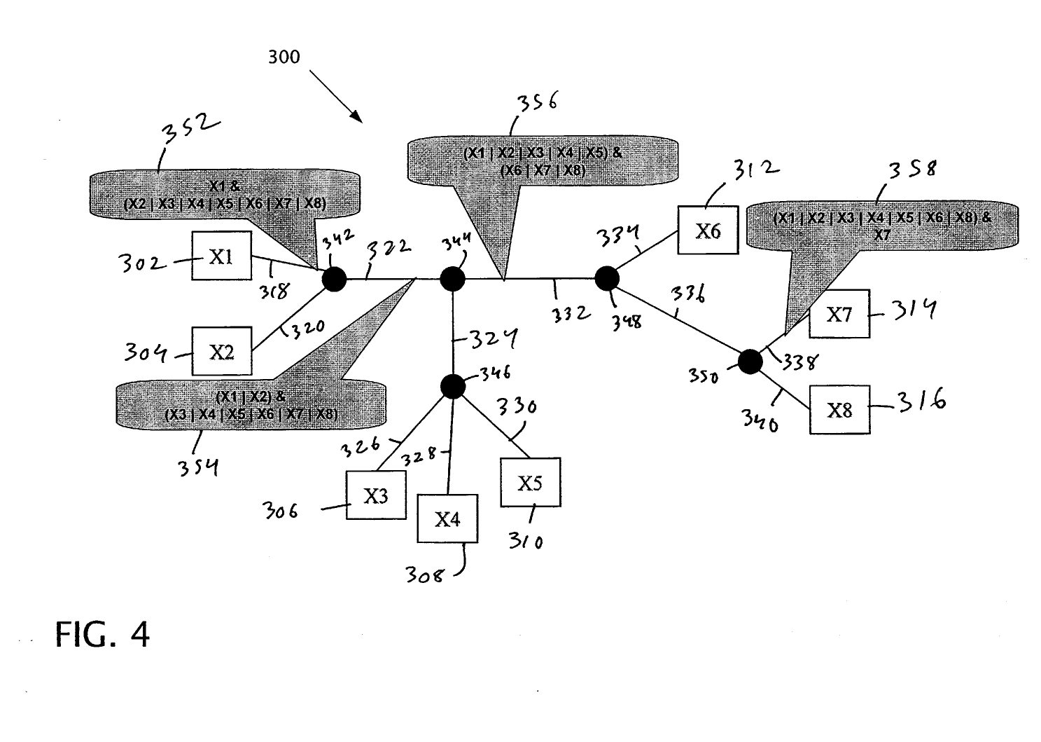

FIG. 4 shows the exemplary set 300 of electrical devices 302-316, wires 318-340, and splices 342-350. FIG. 4 also shows various wire option expressions 352-358 calculated for respective corresponding wires 318, 322, 332, and 338. For example, wire option expression 352 is determined with respect to wire 318 and the electrical devices with which it is connected (e.g., component 302 and the components electrically connected through splice 342).

In the example, a wire option expression can be calculated for any wire by taking into account the electrical device option expressions on either side of the wire. Also, a determination may be made as to whether the wire is required for the wiring harness design. For example, a wire can be deemed required for the given design if any of the electrical device option expressions on one side of the wire are true and any of the electrical device option expressions on the other side of the wire are true.

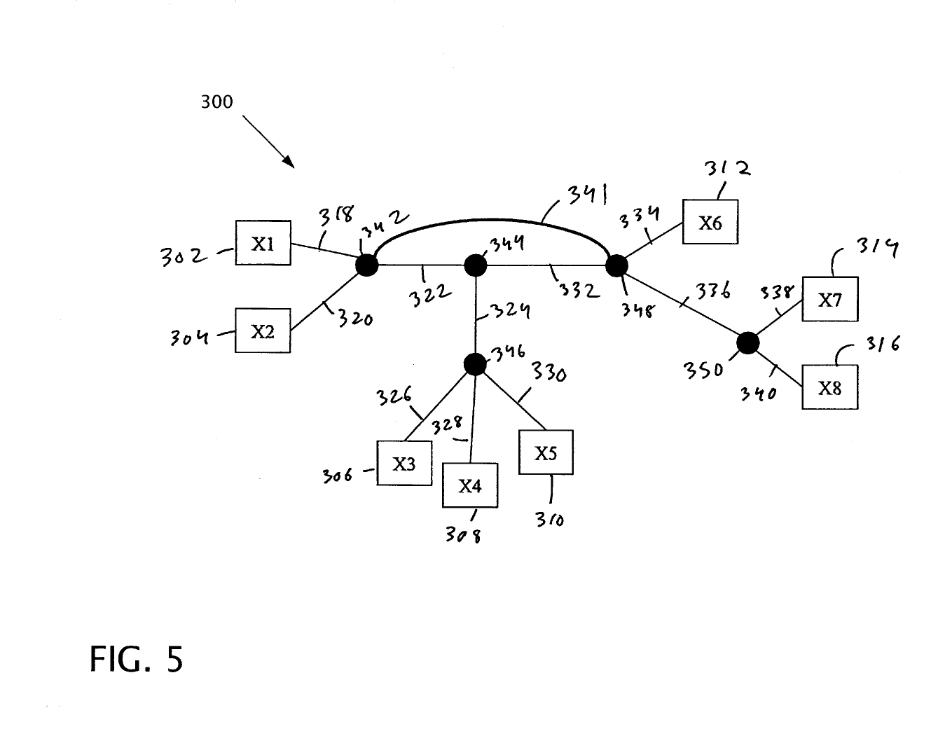

FIG. 5 shows the exemplary set 300 of electrical devices 302-316, wires 318-340, and splices 342-350. FIG. 5 also shows a bypass wire 341 located between two splices 342 and 348. The bypass wire 341 is placed between two splices 342 and 348 and provides a bypass of several electrical devices 306-310, wires 322-332, and splices 344 and 346.

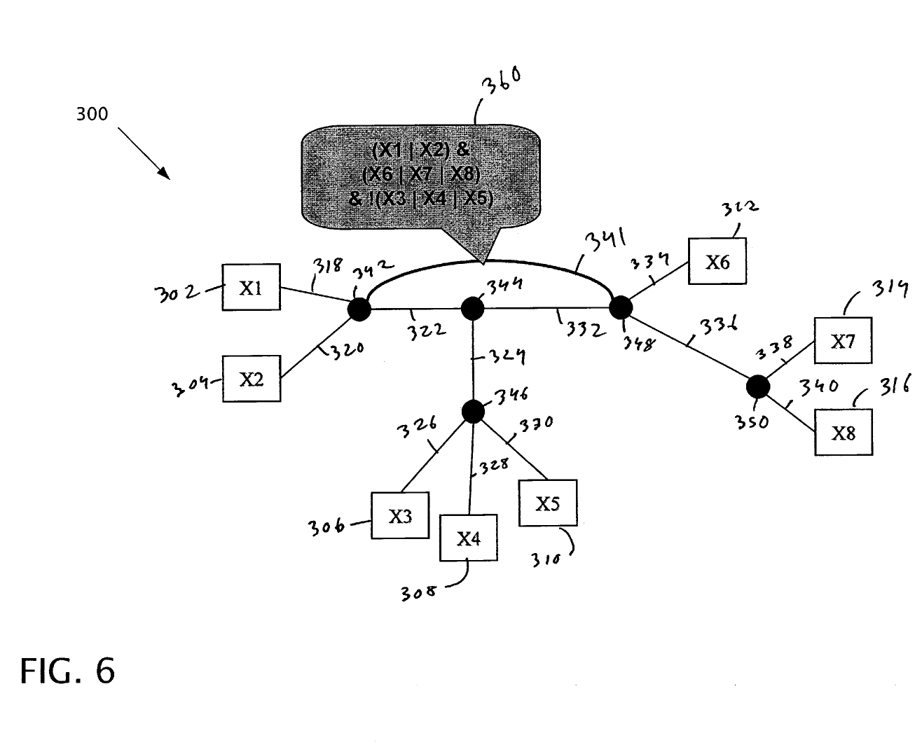

FIG. 6 shows the exemplary set 300 of electrical devices 302-316, wires 318-340 and bypass wire 341, and splices 342-350. A wire option expression 360 is determined with respect to bypass wire 341.

In the example, the bypass wire 341 can be determined to be required for the wiring harness design if any of the electrical device option expressions on one side (e.g., X1 and X2) are true, any of the electrical device option expressions on the other side (e.g., X6, X7, and X8) are true, and none of the electrical device option expressions corresponding to the bypassed electrical devices (e.g., X3, X4, and X5) are true.

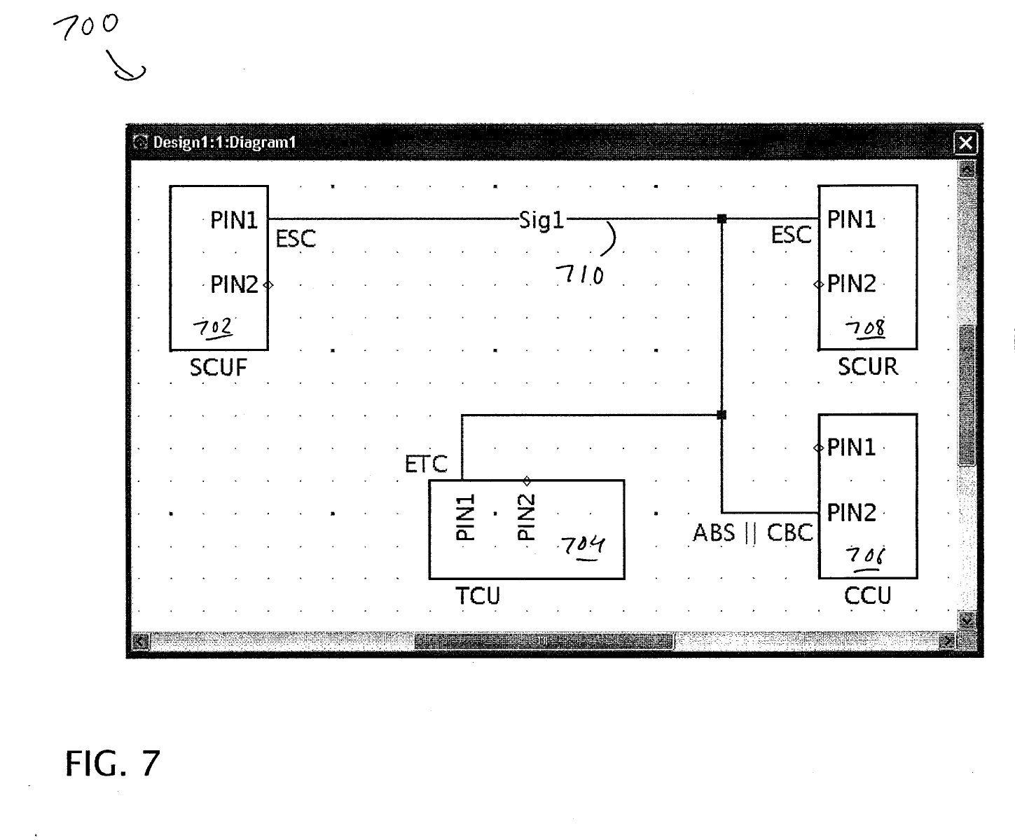

FIG. 7 shows an exemplary logic design 700 that includes several electrical devices 702-708 that each have multiple pins (e.g., PIN1 and PIN2) and a signal 710 routed between each of the four electrical devices 702-708. Signals are generally used in logic designs but can be replaced with wires after a synthesis operation on the design.

In the example, the electrical devices 702-708 have electrical device option expressions ESC, ETC, ABS|CBC, and ESC, respectively, assigned to pins that connect to the signal 710. Each electrical device option expression can be placed (e.g., by or a user, semi-automatically such as in response to a user command, or automatically) on the respective electrical device itself or on the corresponding pin of the respective electrical device. For example, because the first electrical device 702 has two pins but a signal routed to only one of them, the corresponding electrical device option expression ESC can be placed on either the electrical device 702 itself or on the associated pin (PIN1) of the electrical device 702.

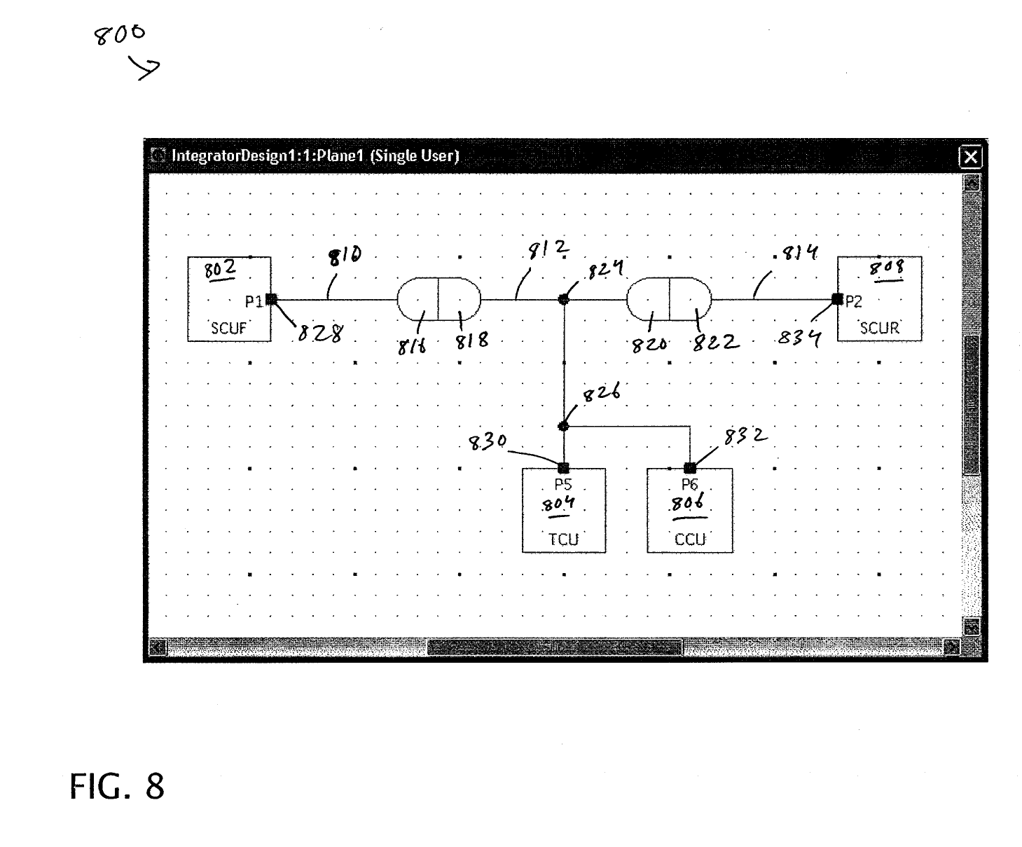

FIG. 8 shows an exemplary integration design 800 resulting from replacing the electrical devices 702-708 of FIG. 7 with slots 802-808 and splitting the signal 710 of FIG. 7 into three separate harnesses (e.g., bundles) 810-814 using inline connectors 816-822. The first harness 810 is connected to one end 816 of a first inline connector, the mating end 818 of which being connected to the second harness 812. The second harness 812 is also connected to one end 820 of a second inline connector, the mating end 822 of which being connected to the third harness 814. The second harness has two takeouts (e.g., wire splits) 824 and 826. At this point, a synthesis operation may be performed on the design (e.g., the wires).

The integration design 800 also includes four cavities (e.g., for receiving pins on an electrical device) 828-834 on the slots 802-808, respectively. Each cavity can have an option expression corresponding to the pin of the electrical device assigned to the cavity. For example, the first cavity 828 has an option expression ESC because the pin PIN1 on the electrical device 702 of FIG. 7, which has an electrical device option expression ESC, is assigned to the first cavity 828 on the first slot 802 of FIG. 8.

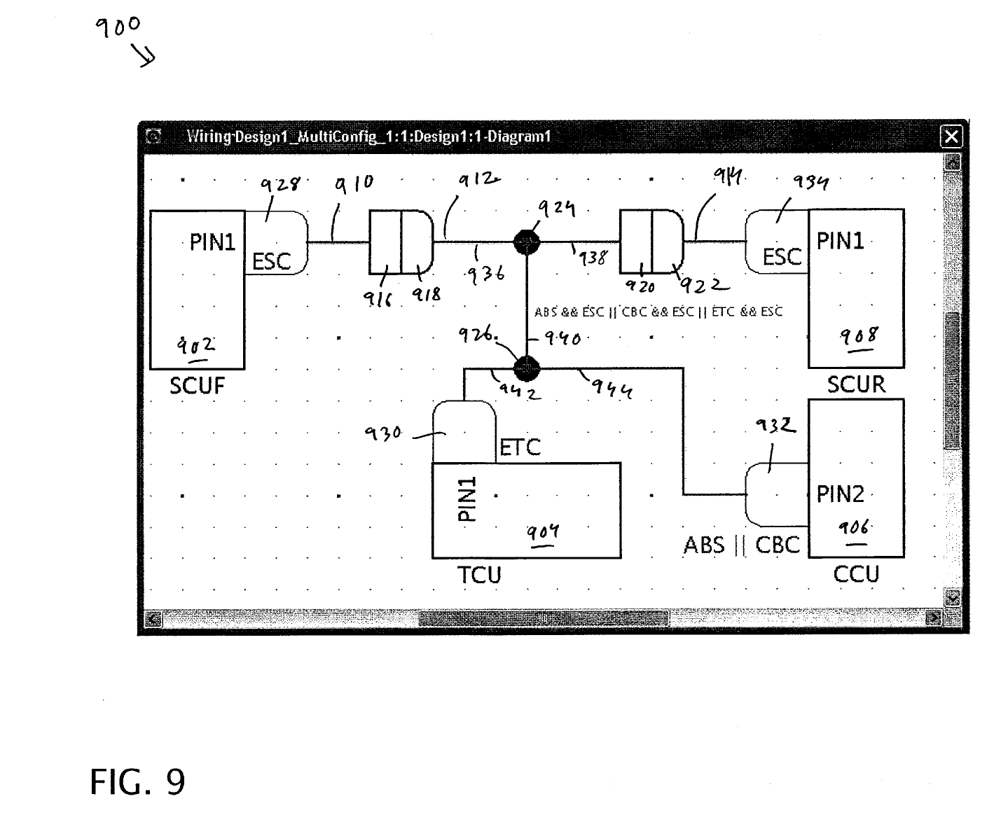

FIG. 9 shows an exemplary wiring design 900 resulting from performing a synthesis operation on the exemplary integration design 800 of FIG. 8. Four slots 902-908 correspond to the slots 802-808 of FIG. 8. Four connectors 928-934 correspond to (e.g., can connect to) the cavities 828-834 of FIG. 8, respectively. Three wire harnesses (e.g., wire bundles) 910-914 correspond to the three harnesses 810-814 of FIG. 8. The first wire harness 910 and third wire harness 914 are both single-wire harnesses, whereas the second wire harness 912 is split by two splices 924 and 926 (which correspond to the two splices 824 and 826 of FIG. 8) into five distinct wires 936-944.

In the example, wire option expressions can be generated for the first and third single-wire wire harnesses 910 and 914. Wire option expressions can also be generated for each of the fives wires 936-944 in the second wire harness 912. In this example, an initial wire option expression “(ESC|ESC) & (ETC|(ABS|CBC))” can be determined for the middle wire 940 of the second wire harness 912. The initial wire option expression can be simplified (e.g., into a “sum of products” form) to “ABS & ESC|CBC & ESC|ETC & ESC.” In the example, the simplified wire option expression is also the final wire option expression because it is already in its most simplified form (e.g., subsequent application of a reduction algorithm such as ESPRESSO would not alter the simplified wire option expression).

While the present example is simplistic, however, the disclosed technology can be applied to wires in designs having substantially greater complexity.

### SPECIFIC EXAMPLE

In an illustrated example, assume an initial wire option expression is (A|B|C & C|D & A|C). The initial wire option expression can be expanded as follows, yielding a number of terms where each term represents one line of a truth table:

```
  (A&C|D&A|C)|(B&C|D&A|C)|(C&C|D&A|C)
  (A&C&A|C)|(A&D&A|C)|(B&C&A|C)|(B&D&A|C)|(C&C&A|C)|
  (C&D&A|C)
  (A&C&A)|(A&C&C)|(A&D&A)|(A&D&C)|
  (B&C&A)|(B&C&C)|(B&D&A)|(B&D&C)|
  (C&C&A)|(C&C&C)|(C&D&A)|(C&D&C)
  (A&C)|(A&C)|(A&D)|(A&D&C)|
  (B&C&A)|(B&C)|(B&D&A)|(B&D&C)|
  (C&A)|(C)|(C&D&A)|(C&D)
```

This results in a truth table containing only 12 rows (as opposed to 16) which, after the removal of duplicate rows, becomes a truth table with only 9 rows as follows:

| A | B | C | D | Out |
|---|---|---|---|---|
| 1 | — | 1 | — | 1 |
| 1 | — | — | 1 | 1 |
| 1 | — | 1 | 1 | 1 |
| 1 | 1 | 1 | — | 1 |
| — | 1 | 1 | — | 1 |
| 1 | 1 | — | 1 | 1 |
| — | 1 | 1 | 1 | 1 |
| — | — | 1 | — | 1 |
| — | — | 1 | 1 | 1 |

The truth table can be simplified. For example, an algorithm (e.g., a minimization algorithm such as the ESPRESSO algorithm) can be applied to the truth table, thereby modifying (e.g., simplifying) the wire option expression, which results in the final wire option expression “(A & D)|C.”

### Exemplary Computer Networks

The disclosed embodiments can be implemented in a wide variety of environments, such as in a computer program product. For example, any of the disclosed techniques can be implemented in software comprising computer-executable instructions stored on computer-readable media (e.g., one or more CDs, volatile memory components (e.g., DRAM or SRAM), or nonvolatile memory components (e.g., hard drives)). This particular software implementation should not be construed as limiting in any way, however, as the principles disclosed herein are generally applicable to other software tools.

Such software can be executed on a single computer or on a networked computer (e.g., via the Internet, a wide-area network, a local-area network, a client-server network, or other such network). For clarity, only certain selected aspects of the software-based implementations are described. Other details that are well known in the art are omitted. For example, it should be understood that the disclosed technology is not limited to any specific computer language, program, or computer. For the same reason, computer hardware is not described in further detail. For example, the disclosed embodiments can be implemented using a wide variety of commercially available computer systems and/or testing systems. Any of the disclosed methods can alternatively be implemented partially or completely in hardware (e.g., an ASIC or a PLD).

Further, wiring harness designs produced from any of the disclosed methods can be created, updated, or stored on computer-readable media (e.g., one or more CDs, volatile memory components (such as DRAM or SRAM), or nonvolatile memory components (such as hard drives)) using a variety of different data structures or formats.

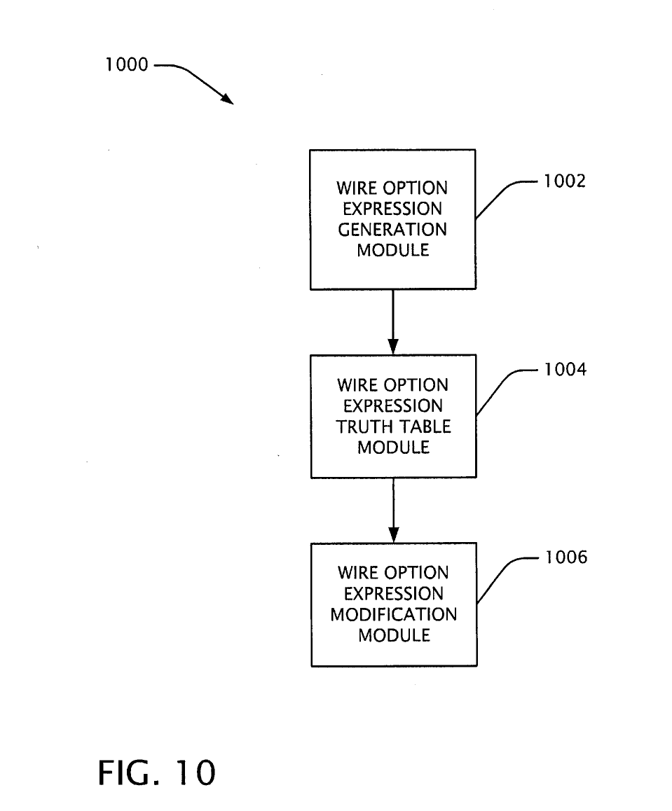

FIG. 10 shows an exemplary computer program product 1000 operable to create and modify a wire option expression. In the example, a wire option expression module 1002 can be used to generate a wire option expression (e.g., an initial wire option expression) corresponding to a wire in a wiring harness design (e.g., in a wiring harness design workspace). The wire option expression module 1002 can use information corresponding to electrical device option expressions assigned to electrical devices with which the wire is electrically coupled, for example.

In the example, a wire option expression truth table module 1004 can be used to generate a wire option expression truth table corresponding to the initial wire option expression and to modify the generated wire option expression truth table. For example, the wire option expression truth table module 1004 can simplify the initial wire option expression (e.g., to a “sum of products” form) to be used in creating the wire option expression truth table.

In the example, a wire option expression modification module 1006 can be used to modify the initial wire option expression (e.g., by using the wire option expression truth table generated by the wire option expression truth table generation module 1004). The modified wire option expression (e.g., final or intermediate) can then be provided as an output (e.g., using a visual display).

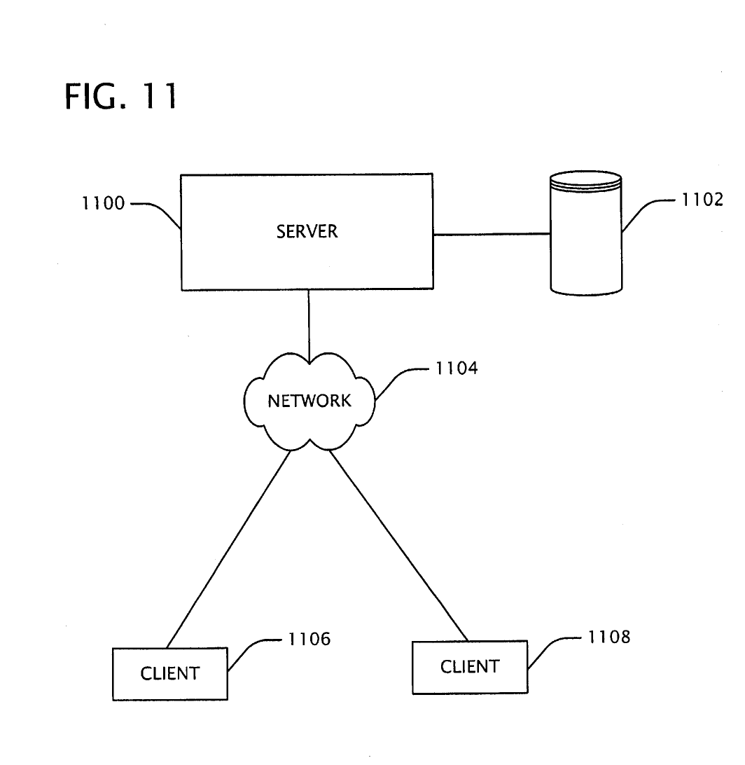

Any of the aspects of the technologies described above can be performed using a distributed computer network. FIG. 11 shows one such exemplary network. A server computer 1100 can have an associated storage device 1102 (internal or external to the server computer). For example, the server computer 1100 can be configured to display wiring harness design information according to any of the disclosed embodiments. The server computer 1100 can be coupled to a network, shown generally at 1104, which can comprise, for example, a wide-area network, a local-area network, a client-server network, the Internet, or other such network. One or more client computers, such as those shown at 1106 and 1108, can be coupled to the network 1104 using a network protocol.

Having shown and described the principles of the illustrated embodiments, it will be apparent to those skilled in the art that the embodiments can be modified in arrangement and detail without departing from such principles. In view of the many possible embodiments, it will be recognized that the illustrated embodiments include only examples and should not be taken as a limitation on the scope of the invention. Rather, the invention is defined by the following claims. I therefore claim as the invention all such embodiments that come within the scope of these claims.

I claim:

1. A computer-implemented method, comprising:
creating a first wire option expression corresponding to a first wire within a wiring harness design in a wiring harness design workspace;
generating a first wire option expression truth table based at least in part on the first wire option expression;
modifying the first wire option expression truth table; and
modifying the first wire option expression based at least in part on the modified first wire option expression truth table.

2. One or more tangible computer readable media comprising computer executable instructions which, when executed by a processor, perform the computer-implemented method according to claim 1.

3. The computer-implemented method of claim 1, further comprising outputting the modified first wire option expression.

4. The computer-implemented method of claim 1, wherein creating the first wire option expression is based at least in part on a first electrical device option expression corresponding to a first electrical device in the wiring harness design workspace.

5. The computer-implemented method of claim 1, wherein the first electrical device is electrically coupled with the first wire.

6. The computer-implemented method of claim 1, wherein modifying the first wire option expression truth table comprises implementing a reduction algorithm to simplify the first wire option expression truth table.

7. The computer-implemented method of claim 1, wherein generating the first wire option expression truth table comprises manipulating the first wire option expression into a sum of products form and translating the sum of products form into the first wire option expression truth table.

8. The computer-implemented method of claim 1, further comprising creating at least the first wire by performing a synthesis operation on at least part of the wiring harness design.

9. The computer-implemented method of claim 1, further comprising:
creating a second wire option expression corresponding to a second wire within the wiring harness design;
generating a second wire option expression truth table based at least in part on the second wire option expression;
modifying the second wire option expression truth table; and
modifying the second wire option expression based at least in part on the modified second wire option expression truth table.

10. The computer-implemented method of claim 8, wherein the second wire comprises a bypass wire.

11. The computer-implemented method of claim 8, further comprising creating at least the first wire and the second wire by performing a synthesis operation on at least part of the wiring harness design.

12. The computer-implemented method of claim 8, wherein creating the second wire option expression is based at least in part on a second electrical device option expression corresponding to a second electrical device in the wiring harness design workspace.

13. A computer program product comprising a wiring harness design tool, the wiring harness design tool comprising:
a wiring harness design workspace in which one or more electrical devices and one or more wires can be placed in a wiring harness design within the wiring harness design workspace; and
a wire option expression generation module operable to generate an initial wire option expression corresponding to one of the one or more wires.

14. The computer program product of claim 13, further comprising a wire option expression truth table module operable to generate a wire option expression truth table based at least in part on the initial wire option expression and to modify the wire option expression truth table.

15. The computer program product of claim 14, further comprising a wire option expression modification module operable to modify the initial wire option expression based at least in part on the modified wire option expression truth table.

16. A computer-implemented method, comprising:
accessing a wiring harness design workspace;
accessing a wiring harness design within the wiring harness design workspace, wherein the wiring harness design comprises one or more wires;
determining a wire option expression, the wire option expression corresponding to one of the one or more wires; and
manipulating the wire option expression to reduce the complexity of the wire option expression.

17. The computer-implemented method of claim 16, further comprising creating the one or more wires by performing a synthesis operation on the wiring harness design.

18. The computer-implemented method of claim 16, further comprising constructing a wire option expression truth table based at least in part on the wire option expression.

19. The computer-implemented method of claim 16, wherein manipulating the wire option expression comprises applying a reduction algorithm to the wire option expression.

20. One or more tangible computer readable media comprising computer executable instructions which, when executed by a processor, perform the computer-implemented method according to claim 16.
